(19) United States
(12) Patent Application Publication
(10) Pub. No.: US 2014/0143675 A1
(43) Pub. Date: May 22, 2014

(54) METHOD AND APPARATUS FOR PROVIDING CONTACT INFORMATION THROUGH INTERWORKING BETWEEN MESSAGING SERVICE AND ANOTHER SERVICE

(71) Applicants: Kyung-Tak Lee, Gyeonggi-do (KR); Wuk Kim, Gyeonggi-do (KR); Gyu-Bong Oh, Gyeonggi-do (KR)

(72) Inventors: Kyung-Tak Lee, Gyeonggi-do (KR); Wuk Kim, Gyeonggi-do (KR); Gyu-Bong Oh, Gyeonggi-do (KR)

(73) Assignee: Samsung Electronics Co., Ltd., Gyeonggi-do (KR)

(21) Appl. No.: 14/130,243

(22) PCT Filed: Jun. 28, 2012
(86) PCT No.: PCT/KR2012/005141

§ 371 Date: Dec. 30, 2013

(30) Foreign Application Priority Data
Jun. 28, 2011 (KR) 10-2011-0063286

(51) Int. Cl. H04L 29/08

(52) U.S. Cl. CPC H04L 67/10
USPC 715/739

(57) ABSTRACT

Disclosed is a method of providing contact information through an interworking between a messaging service and another service, the method including: receiving a preference of a user from an application client by an application server; receiving a request for a list of new contacts from the application client; transferring the request for the list of the new contacts to an interworking server; receiving a profile of the contact from a service provider through the interworking server; filtering the received profile of the contact; and transferring a list of filtered contacts to the application client.

### TECHNICAL FIELD

The present invention relates to a messaging service apparatus and method, and more particularly to a method and an apparatus for providing contact information through interworking between a messaging service and another service, such as a social networking service.

### BACKGROUND ART

A mobile communication terminal is a means capable of providing and exchanging necessary information anytime and anywhere, and had generally used a simple call service in a previous time. However, an importance of the mobile communication terminal is being gradually magnified in an aspect of conversation or information exchange through a text and multimedia. In this respect, various messaging services, such as a Short Message Service (SMS), a Multimedia Messaging Service (MMS), and a Microsoft Network (MSN), and various social networking services, such as Facebook and Twitter, have been provided.

The aforementioned various services are provided based on different technologies, respectively, but there is a case where a user receives an overlapping function and user experience. However, the respective services have inherent characteristics, so that a user is required to subscribe to the respective services in order to experience all characteristics of the respective services.

In order to minimize the burden on the user, new services for combining various user experiences are being introduced and standardized. A representative service includes Converged IP Messaging (CPM) and Global System for Mobile communication Association Rich Communication Suite (GSMA RCS) standardized by the Open Mobile Alliance (OMA). Further, the messaging services use different contacts, so that a necessity of a management of an address book has arisen. According to the necessity, the OMA suggested OMA Converged Address Book (OMA CAB). The OMA CAB is an improved network address book and is characterized by managing various information through utilizing a network storage and enabling the sharing of information between groups.

As described above, in a case of an existing messaging service among newly introduced services, when a user subscribes to the existing messaging service, but a counter user does not subscribe the existing messaging service or another service compatible with the existing messaging service, it is difficult to have a conversation or exchange information through the existing messaging service. Accordingly, when the messaging service is interworked with another service, such as a social network, it is possible to receive an extended address book, thereby becoming capable of extending contact targets.

### DISCLOSURE OF INVENTION

### Technical Problem

In the meantime, a user may mainly receive contact information on friends or older or younger acquaintances, who the user is personally related to, but may also wish to receive contact information on those having no personal relation depending on occasions. For example, when a user visits a foreign country and prefers a Korean food, there is a case in which the user is required to directly search for a Korean restaurant in the foreign country. In this situation, if the user is able to receive contact information on a Korean restaurant located in a neighboring area and additional information, such as a menu, in advance, the convenience of the user may be increased. However, since the aforementioned contact information is generally effective only at a specific place or during a specific time, when the user adds the received information to the address book, the user has a burden in the management, such as manual removal or movement, of the information. Accordingly, a method of automatically managing the information received and added to the address book according to a situation is required.

### Solution to Problem

In accordance with a first aspect of the present invention, there is provided a method of providing contact information through an interworking between a messaging service and another service, the method including: receiving a preference of a user from an application client by an application server; receiving a request for a list of new contacts from the application client; transferring the request for the list of the new contacts to an interworking server; receiving a profile of the contact from a service provider through the interworking server; filtering the received profile of the contact; and transferring a list of filtered contacts to the application client.

The filtering of the received profile of the contact includes: extracting data, from which the contact can be identified, from the received profile of the contact; comparing the extracted data, from which the contact can be identified, with data of an address book stored in an address book management unit of the application server, and determining if the received profile of the contact corresponds to the data stored in the address book; when the received profile of the contact does not correspond to the data stored in the address book, extracting data corresponding to the preference of the user from the received profile of the contact; determining if the extracted data corresponding to the preference of the user corresponds to a preference of the user stored in a preference management unit of the application server; and when the extracted data corresponding to the preference of the user corresponds to the preference of the user stored in the preference management unit of the application server, adding an indication of being a temporary contact to the received profile of the contact.

The data from which the contact can be identified includes at least one of a name, an email address, a telephone number, and a received service.

In accordance with a second aspect of the present invention, there is provided an application server for providing contact information through an interworking between a messaging service and another service, the application server including: a memory for storing data necessary for operating the application server and storing a list of contact profiles received from a service provider; an I/O interface for transceiving information with other system elements; an address book management unit for storing information on an address book synchronized with an address book of an application client; and a controller for receiving a preference of a user from the application client, receiving a request for a list of new contacts from the application client, transferring the request for the list of the new contacts to an interworking server, receiving a profile of the contact from a service provider through the interworking server, filtering the received profile of the contact, and transferring a list of filtered contacts to the application client.

The application server further includes a preference management unit for storing the preference of the user received from the user.

In accordance with a third aspect of the present invention, there is provided a method of receiving contact information through an interworking between a messaging service and another service, the method including: transmitting a request for a list of new contacts to an application server by an application client; receiving a list of filtered contacts from the application server by the application client; displaying the received list of the filtered contacts; adding the received list of the filtered contacts to an address book; and removing the added list of the filtered contacts according to a preset standard.

The removing of the added list of the filtered contacts according to the preset standard includes: identifying if a profile of the added contact includes an indication of being a temporary contact; when the profile of the added contact includes the indication of being the temporary contact, identifying a storage standard of the profile of the contact including the indication of being the temporary contact; when the profile of the contact including the indication of being the temporary contact satisfies the storage standard, periodically checking the storage standard; and when the profile of the contact including the indication of being the temporary contact does not satisfy the storage standard, removing the profile of the contact including the indication of being the temporary contact.

The storage standard includes at least one of a location of the application client and a preset term.

In accordance with a fourth aspect of the present invention, there is provided an application client for receiving contact information through an interworking between a messaging service and another service, the application client including: a memory for storing data necessary for operating the application client; an I/O interface for transceiving information with other system elements; an address book management unit for storing information on an address book; a user interface for inputting/outputting data; and a controller for transmitting a request for a list of new contacts to an application server, receiving a list of filtered contacts from the application server, displaying the received list of the filtered contacts, adding the received list of the filtered contacts to the address book, and removing the added list of the filtered contacts according to a preset standard.

### Advantageous Effects of Invention

The present invention has an advantage of extending contact targets by receiving an extended address book from another service during the use of a messaging service. Accordingly, the user may automatically receive new contacts which are not included in the user's address book, and may easily and temporarily connect to another contact, such as a restaurant, which the user does not know but is related to the profile and the preference of the user, as well as existing friends and family members included in the address book. Further, when the user newly subscribes to a specific service, the present invention enables the user to conveniently and directly use the specific service.

### BRIEF DESCRIPTION OF DRAWINGS

FIG. 1 is a diagram illustrating a system for providing new contacts and managing temporary contacts according to an embodiment of the present invention.

FIG. 2 is a flowchart illustrating an operation of providing contacts through interworking with another service according to an embodiment of the present invention.

FIG. 3 is a block diagram illustrating an internal structure of an application server of FIG. 2.

FIG. 4 is a flowchart illustrating an operation of an application server of FIG. 2.

FIG. 5 is a block diagram illustrating an internal construction of an application client of FIG. 2.

FIG. 6 is a flowchart illustrating an operation of an application client of FIG. 2.

FIG. 7 is a diagram illustrating a CAB service used in the present invention.

FIG. 8 is a flowchart illustrating a process of providing contacts according to a first embodiment of the present invention.

FIG. 9 is a flowchart illustrating a process of providing contacts according to a second embodiment of the present invention.

FIG. 10 is a flowchart illustrating a process of providing contacts according to a third embodiment of the present invention.

FIG. 11 is a flowchart illustrating a process of providing contacts according to a fourth embodiment of the present invention.

### BEST MODE FOR CARRYING OUT THE INVENTION

Hereinafter, an exemplary embodiment of an apparatus and an operation method of the present invention will be described with reference to the accompanying drawings. Further, various specific items, such as elements, found in the following description are provided only to help general understanding of the present invention, and it is apparent to those skilled in the art that the specific definitions of the present invention can be modified or changed within the scope of the present invention.

In the following description, a detailed explanation of known related functions and constitutions may be omitted to avoid unnecessarily obscuring the subject matter of the present invention.

In the following description, a representative embodiment of the present invention for achievement of the aforementioned technical aspect will presented. For convenience's sake, names of entities defined in the Converged Address Book (CAB) of the Open Mobile Alliance (OMA), which is a standards organization of an application for a mobile terminal, and the Rich Communication Suite (RCS) of the Global System for Mobile communication Association (GSMA) will be used. However, the standards and the names do not limit the scope of the present invention, and may be applied to a system having a similar technical background as a matter of course.

The present invention suggests a method and an apparatus for providing contacts through interworking with another service, and a method of managing temporary contacts. To this end, the present invention includes a process of receiving contacts provided from another service by a client using a messaging service through interworking with the another service and a process of, when it is determined that the received contact is not necessary any more according to a specific standard, e.g. a real time location distance between a location of a user and a location according to the contact, automatically processing (e.g. removal) the received contact by the client. Accordingly, the client using the messaging service may easily extend temporarily necessary contact in an address book, and directly manage (e.g. remove) the contact without a necessity of separate measures by the user when the contact is not necessary any more.

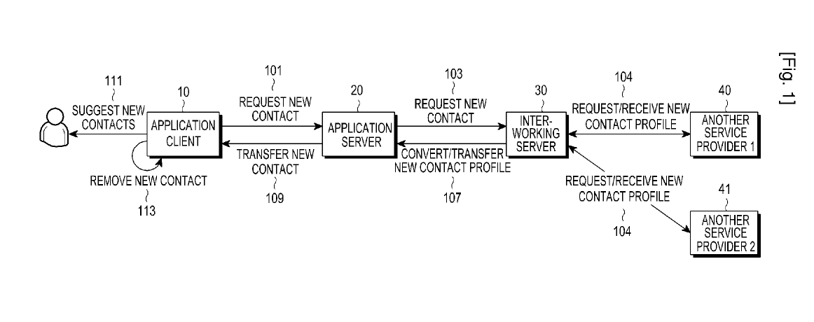

A construction of a system for providing contacts and managing temporary contacts having the aforementioned function is illustrated in FIG. 1.

FIG. 1 is a diagram illustrating the construction of the system for providing new contacts and managing temporary contacts according to an embodiment of the present invention.

Referring to FIG. 1, an application client 10 is an application messaging service program operated in a user terminal. The application client 10 functions to transfer demands of the user to an application server 20 existing in a network and notify the user of an event or a message received from the application server 20. Here, the embodiment of the present invention will be described based on an RCS service as an example of the application messaging service. The application client 10 may be operated as a CAB client.

The application server 20 processes a user's demand received from the application client 10. Further, the application server 20 transfers an event or a message received from an interworking server 30 or another network to the application client 10.

The interworking server 30 serves as a gateway for connecting the application server 20 to other responsible service providers 40 and 41, and serves as an important intermediate medium for converting the event or the message into a format appropriate between the application server 20 and the other service providers 41 and 41. When the system according to the present invention is actually implemented, the interworking server 30 may be generally located at the same place as that of the application server 20 or may be included as an internal element of the application server 20.

The other service providers 40 and 41 are organizations for providing other services discriminated from the messaging service. For example, in a case of the social networking service, the other service providers 40 and 41 are organizations, such as Facebook or Twitter.

Referring to the system illustrated in FIG. 1, in the operation of providing the contact according to the present invention, the application client 10 first makes a request for new contacts to the application server 20 in an operation 101. The application server 20 makes a request for the new contacts to the interworking server 30 in an operation 103. The interworking server 30 makes a request for a new contact profile to the other service providers 40 and 41 and receives information on the new contact profile in an operation 104. Next, the interworking server 30 converts the new contact profile received from the other service providers 40 and 41 and transfers the converted new contact profile to the application server 20 in an operation 107. The application server 20 transfers the new contact to the application client 10 in an operation 109. The application client 10 suggests the new contact to the user in an operation 111. Then, the application client 10 compares the received new contact with a new contact removal standard, and removes the new contact from the address book when the new contact does not satisfy the new contact removal standard in an operation 113.

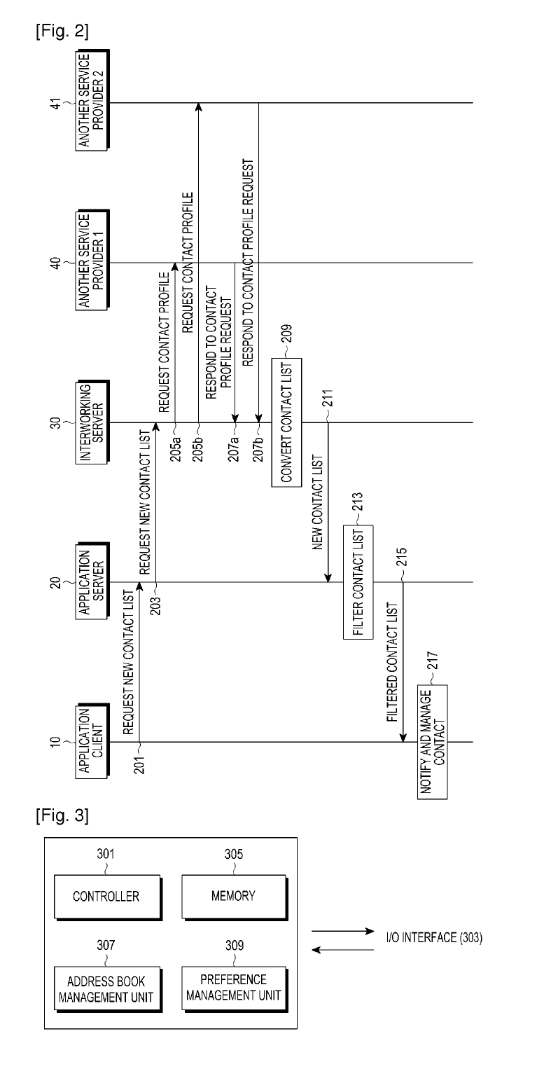

A process of providing the contact in the system illustrated in FIG. 1 will be described with reference to FIG. 2 in detail. FIG. 2 is a flowchart illustrating the operation of providing the contact through interworking with other services according to the embodiment of the present invention.

Referring to FIG. 2, it is on a premise that a terminal of user A, i.e. the application client A 10, simultaneously subscribes to service M and other services. Accordingly, there are a log-in ID and a password of user A accessible to an SNS service, and the interworking server 30 is in a state of logging in to the other service providers 40 and 41 instead of user A and is accessible to the other service providers 40 and 41. It is premised that if the interworking server 30 is not able to directly log in the other service providers 40 and 41, the interworking server 30 first requests user A to log in to the other service providers 40 and 41 through the application client A 10 and then the application client A 10 logs in to the other service providers 40 and 41.

Referring to FIG. 2, the application client 10 makes a request for a list of new contacts to the application server 20 in step 201. The request for the list of the new contacts may be made by executing the application client 10 or accessing the service by the user. The request is made for the purpose of receiving a list of profiles of the new contacts in accordance with a corresponding condition, i.e. a user's preference, such as a kind of food, a restaurant, a type of music, and an event preferred by the user. Here, the new contact profile includes a name, an email address, a telephone number, etc.

Then, the application server 20 transfers the request to the interworking server 30 in step 203. In response, the interworking server 30 makes a request for one or more necessary demands in accordance with the request of the application server 20 to the other service providers 40 and 41 in steps 205a and 205b. Then, the interworking server 30 receives a response to the request from the other service providers 40 and 41 in steps 207a and 207b.

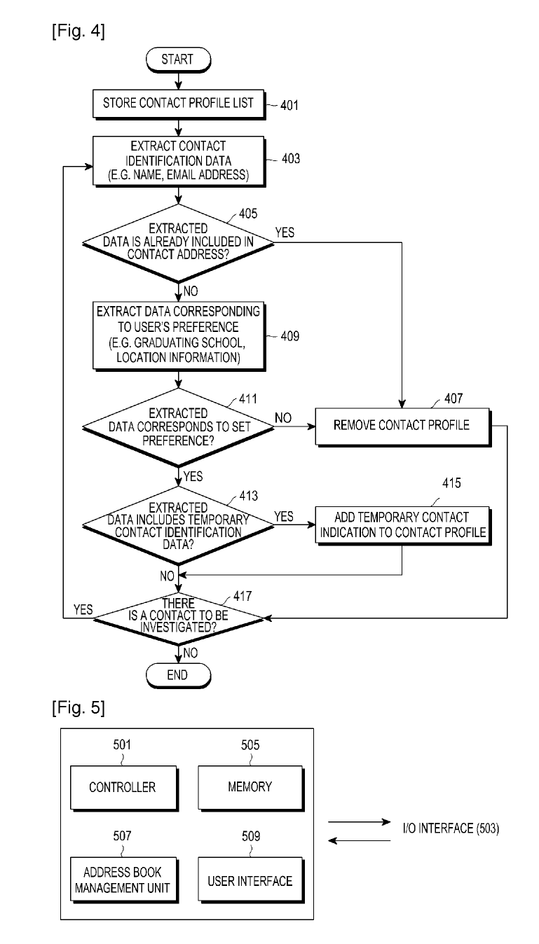

When the interworking server 30 receives the list of profiles of the new contacts as described above, the interworking server 30 converts the received list of the new contact profiles in step 209 and transfers the converted list of the new contact profiles to the application server 20 in step 211. The application server 20 filters contacts effective to the user from the respective received contact profiles in step 213. Here, the address book and the preference of the user are stored in the network, and the application server 20 may access the address book and the preference. Accordingly, the application server 20 may filter the contact, which will be described later with reference to FIG. 4 in detail.

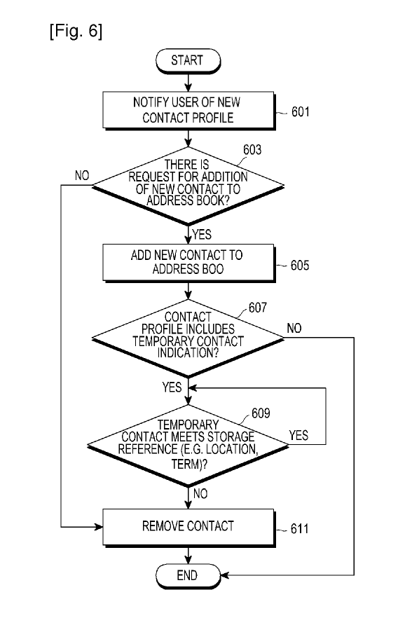

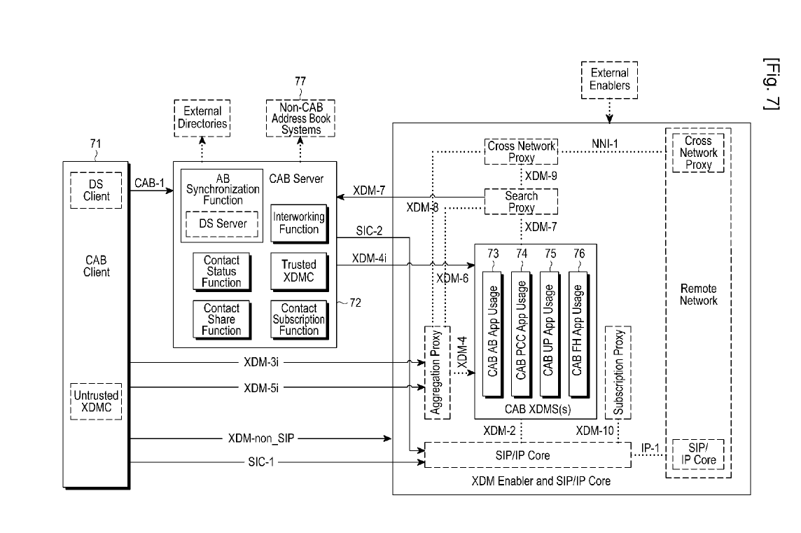

Next, the application server 20 sends the list of the filtered contacts to the application client 10 in step 215. Then, the application client 10 notifies the user of the corresponding matter, and when the user makes a request for an addition of the contact to the address book, the application client 10 adds the contact to the address book and manages the address book in step 217. The notification to the user and the addition and the management of the contact will be described later with reference to FIG. 6 in detail.

Hereinafter, an internal construction of the application server will be described with reference to FIG. 3 prior to describing the operation of the application server for performing the filtering for the contact.

FIG. 3 is a block diagram illustrating an internal structure of the application server of FIG. 2. Referring to FIG. 3, a controller 301 controls every operation of the application server 20 and notifies other internal construction elements of an operation to be performed and a time of the operation through the connection with the other internal construction elements. An I/O interface 303 is used for transmitting/receiving information to/from other system elements. A memory 305 temporally stores processing data when the application server 20 performs an operation. Further, an address book management unit 307 stores existing contact information of the user and stores an address book synchronized with an address book included in an address book management unit 507 used in the application client 10. A preference management unit 309 stores and manages user's preference. The address book management unit 307 and the preference management unit 309 may be implemented while being separated from the application server 20 according to the embodiment of the present invention.

The application server 20 including the aforementioned construction performs the filtering on the contact. The filtering is performed under the control of the controller 301 of the application server 20.

The application server 20 according to the embodiment of the present invention includes the memory 305 for storing data required for an operation of the application server and storing the list of the contact profiles received from the service provider, the I/O interface 303 for transceiving information with other system elements, the address book management unit 307 for storing information on an address book synchronized with the address book of the application client, and the controller 301 for receiving user's preference from the application client, receiving a request for a list of new contacts from the application client, transferring the received request for the list of the new contacts to the interworking server, receiving profiles of the contacts from the service providers through the interworking server, filtering the received contact profiles, and transferring a list of the filtered contacts to the application client.

FIG. 4 is a flowchart illustrating an operation of the application server of FIG. 2. Referring to FIG. 4, the controller 301 stores a list of contact profiles received through the I/O interface 303 in the memory 305 in step 401. The controller 301 extracts data, e.g. a name, an email address, a telephone number, and a received service (e.g. Facebook), from which a contact may be identified, from the list of the contact profiles stored in the memory 305 in step 403. Then, the controller 301 compares the extracted data and corresponding data included in the address book management unit 307 and determines if the extracted data corresponds to a contact already existing in the address book in step 405. As a result of the determination, when it is determined that the extracted data corresponds to the contact existing in the address book, the controller 301 removes the contact profile in step 407.

However, when the extracted data does not correspond to the contact already existing in the address book as the result of the determination in step 405, the controller 301 extracts data corresponding to the user's preference from the contact profile in step 409. In this case, the controller 301 also extracts preference data (e.g. a location distance, a time) corresponding to a temporary contact. The controller 301 identifies if the extracted data corresponds to user's preference (e.g. within the location distance of 200 m) stored in the preference management unit 309 in step 411, and when the extracted data does not correspond to the user's preference stored in the preference management unit 309, the controller 301 removes the contact profile in step 407. However, when the extracted data corresponds to the user's preference stored in the preference management unit 309 as a result of the identification of step 411, the controller 301 proceeds to step 413 of identifying if the contact profile contains data corresponding to the user's preference or contact data which may be identified as a temporary contact. For example, when the user's preference is a distance within 200 m and a distance of the contact (e.g. a restaurant) is within 100 m, the extracted distance corresponds to the user's preference, but the location distance between the user and the contact is easily changed according to the movement of the user, so that the extracted data is determined as the temporary contact. For another example, when a present date is January 5 and a term corresponding to the contact is from January 1 to January 10, the contact is effective based on the present date, but may be determined as an invalid contact when the date is past the term, so that the extracted data may be determined as the temporary contact. When the contact profile includes the data corresponding to the user's preference or the contact data, the controller 301 adds an indication of being a temporary contact to the contact profile in step 415.

Then, the controller 301 determines if there is another contact profile to be investigated in step 417. When there is another contact profile to be investigated, the controller 301 returns to step 403 and repeats the aforementioned processes. However, there is no contact profile to be investigated, the controller 301 completes the internal filtering operation.

An internal construction of the application client will be described with reference to FIG. 5 prior to describing the application client for identifying the registration to a contact providing service and making a notification to the user.

FIG. 5 is a block diagram illustrating the internal construction of the application client of FIG. 2. Referring to FIG. 5, a controller 501, which is an element for controlling every operation of the application client 10, functions to notify other internal elements of a time and an operation to be performed while connecting with the another internal element. An I/O interface 503 is used for transmitting/receiving information to/from another system element. A memory 505 temporally stores processing data when the application client 10 performs an operation. An address book management unit 507 is a storage containing the existing a contact of the user and is synchronized with the address book included in the address book management unit 307 of the application server 20. A user interface 509 is used for displaying all information on the user or inputting information by the user.

The application client 10 according to the embodiment of the present invention includes the memory 505 for storing data necessary for an operation of the application client, the I/O interface 503 for transceiving information with other system elements, the address book management unit 507 for storing address book information, the user interface 509 for the data input/output, and the controller 501 for transmitting a request for a list of new contacts to the application server, receiving a list of filtered contacts from the application server, displaying the received list of the filtered contacts, adding the received list of the filtered contacts to the address book, and removing the added contact according to a preset standard.

The application client 10 having the aforementioned constructions makes a notification to the user and manages the contact as illustrated in FIG. 6. Such an operation is performed under the control of the controller 501 of the application client 10. FIG. 6 is a flowchart illustrating an operation of the application client of FIG. 2.

Referring to FIG. 6, the controller 501 notifies the user of the received filtered contacts through the I/O interface 503 in step 601. The controller 501 waits for a user's determination on whether to add a list of the new contacts to the address book in step 603. When the user makes a request for an addition of the list of the new contacts to the address book, the controller 501 adds list of the new contacts to the address book in step 605. However, when the user does not make a request for an addition of the list of the new contacts to the address book, the controller 501 removes the contact in step 611 and completes the operation of the application client 10. When the controller 501 adds the list of the new contacts to the address book, the controller 501 identifies if the contact profile includes an indication of being a temporary contact in step 607. When the contact profile does not include the indication of being the temporary contact, the contact is required to be continuously stored, so that the controller 501 completes the operation of the application client 10. When the contact profile includes the indication of being the temporary contact, it is necessary to store the contact only up to a time when the contact corresponds to a specific standard (e.g. within a distance of 200 m between a present location of the user and a location of the contact). Accordingly, the controller 501 may make a configuration such that the temporary contact is periodically checked as to if it is corresponds to a storage standard in step 609. When the temporary contact corresponds to the storage standard, the controller 501 returns to step 609 to regularly check the storage standard. When the temporary contact does not correspond to the storage standard, the controller 501 removes the contact in the address book in step 611. Alternatively, the controller 501 may first make a request for confirmation on the removal of the contact to the user and remove the contact when the controller 501 receives the confirmation on the removal in step 611. Alternatively, the controller 501 may shift the contact to another storage, such as a removed contact storage, without permanently removing the contact in step 611. After the performance of step 611, the application client 10 completes the operation.

Hereinafter, when it is assumed that the user of the application client 10 subscribes to the RCS, the RCS provides the service through a combination of multiple enablers and a profiling. In the embodiment of the present invention, the present invention may extend a subject seeking to grasp the success or failure of subscribing to the service through interworking between the RCS service and the SNS service. The RCS may be provided based on the CAB of the OMA, which is an example of the enabler providing an address book convergence function.

Accordingly, the application client 10 of FIG. 2 may be operated as a CAB client in order to receive a list of new contacts. Therefore, the system for providing a contact through interworking with the SNS service according to the present invention may be implemented based on a CAB enabler.

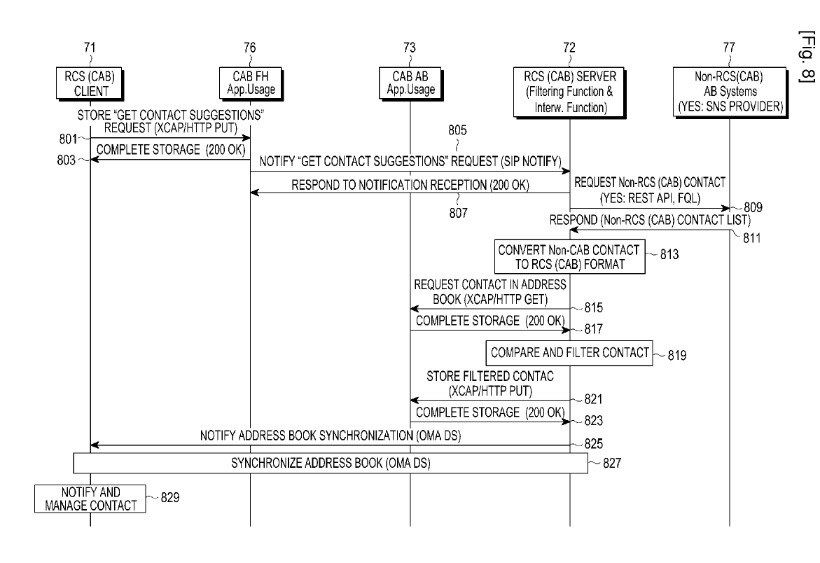

Prior to describing the present invention, a construction of a general CAB system used in the present invention will be described with reference to FIG. 7.

FIG. 7 is a diagram illustrating a CAB service used in the present invention. Referring to FIG. 7, a CAB client 71 is an application program for managing and controlling an address book included in a user's terminal. A CAB server 72 is a main network element for performing various demands of the user received from the CAB client 71. Especially, an interworking function capable of enabling the CAB system to interwork with another address book system (e.g. the vCard) is also included in the CAB server 72. A CAB Address Book (AB) application usage 73 is a server for storing and managing the address book of the user. A CAB Personal Contact Card (PCC) application usage 74 is a server for storing and managing a profile of the user.

A CAB user preferences application usage 75 is a server for storing and managing preference of the user.

A CAB Feature Handler (FH) application usage 76 is a server for storing and managing specific demands of the user. Non-CAB address book systems 77 include all address book systems which are not used in the CAB service, and for example, includes the vCard. In the present invention, it may be assumed that the other service providers 40 and 41 previously described with reference to FIG. 2 are included in the Non-CAB address book system.

Interfaces and protocols/technologies used in the present invention are as follows.

A CAB-1 interface is used when the address book of the CAB client 71 is desired to be first synchronized with the address book stored in the CAB AB application usage 73 through the CAB server 72. Further, the CAB-1 interface is used when the CAB server 72 notifies the CAB client 71 that there is a change between the two address books. OMA DS/SyncML[1] is used as the protocol/technology.

An SIC-1 interface is used for making a notification of changed matters to the CAB client 71 whenever data stored in the CAB PCC application usage 74, the CAP user preferences application usage 75, and the CAB FH application usage 76 is changed. For reference, the CAB-1 interface is used for the notification of the change of the data stored in the CAB AB application usage 73. Session Initiation Protocol (SIP)-Specific Event Notification [2] is used as the protocol/technology.

An SIC-2 interface is used for making a notification of changed matters to the CAB server 72 whenever data stored in the CAB AB Application Usage 73, the CAB PCC Application Usage 74, the CAB User Preferences Application Usage 75, and the CAB FH Application Usage(76). SIP-Specific Event Notification [2] is used as the protocol/technology.

An XDM-3i interface is used when the CAB client 71 manages data stored in the CAB PCC Application Usage 74, the CAB User Preferences Application Usage 75, and the CAB FH Application Usage 76. XML Configuration Access Protocol/Hyper Text Transfer Protocol (XCAP/HTTP)[3] is used as the protocol/technology.

An XDM-4i interface is used when the CAP server 72 manages data stored in the CAB AB Application Usage 73, the CAB PCC Application Usage 74, the CAB User Preferences Application Usage 75, and the CAB FH Application Usage 76. XML Configuration Access Protocol/Hyper Text Transfer Protocol (XCAP/HTTP)[3] is used as the protocol/technology.

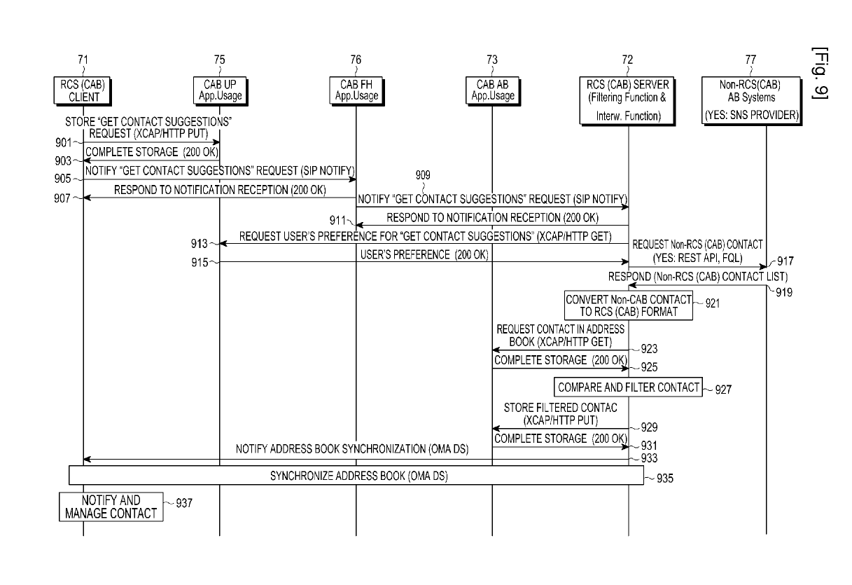

Hereinafter, a case of reconfiguration of the flow of the operation of providing the contact illustrated in FIG. 2 according to the embodiment of the present invention based on the construction of FIG. 7 will be described in detail. A construction of a system in which the RCS service reconfigured based on the construction of FIG. 7 interworks with the SNS service according to the embodiment of the present invention will be implemented as illustrated in FIGS. 8 to 11.

First, FIG. 8 is a flowchart illustrating a process of providing contacts according to a first embodiment of the present invention. FIG. 8 illustrates an example of a case in which the application server 20 is integrated with the interworking server 30. For the convenience of description, elements, e.g. SIP/IP cores, IMS, and an aggregation proxy, for a routing or other purposes, are omitted, but it may be assumed that these elements are used depending on a necessity. Further, in the following drawings, the RCS service of FIG. 2 is reconfigured based on the construction of the CAB service, so that names used in the RCS may be replaced with those used in the CAB and the RCS is indicated in parallel with the CAB. Likewise, the other service providers 41 and 41 of FIG. 2 may be indicated in parallel with the Non-CAB.

Referring to FIG. 8, when the user accesses the RCS service, the RCS (CAB) client 71 requests the CAB FH application usage 76 to store detailed information on a request in a document, CAB feature handler, managed by the CAB FH application usage 76 in order to receive a new contact suggestion list. To this end, Get Contact suggestions is transferred to the CAB FH application usage 76 in a form of XCAP/HTTP PUT in step 801. The document, CAB Feature Handler, will be described later.

The CAB FH application usage 76 stores the request in the document, CAB Feature Handler, managed by itself and sends 200 OK as a storage completion response to the RCS (CAB) client 71 in step 803. Then, the CAB FH application usage 76 notifies the RCS (CAB) server 72 of the request of the RCS (CAB) client 71 stored in the document, CAB Feature Handler† and information in step 805. An SIP NOTIFY message is used for the notification. The RCS(CAB) server 72 receives the notification and sends 200 OK as a confirmation message to the CAB FH application usage 76 in step 807. The RCS (CAB) server 72 reviews the request and makes a request for a Non-RCS (CAB) contact to the Non-RCS(CAB) address book systems 77 by converting the request into an appropriate format. Here, the Non-RCS(CAB) address book systems 77 correspond to the other service providers 40 and 41 (e.g. the SNS providers). Further, in FIG. 8, the example of the Non-RCS(CAB) address book systems 77 corresponding to one SNS provider has been described, but it is a matter of course that when there are a plurality of SNS providers, the RCS (CAB) server 72 may receive contacts from the plurality of SNS providers and combine the received contacts.

Accordingly, the Non-RCS (CAB) address book systems 77 sends the requested Non-RCS (CAB) contact to the RCS (CAB) server 72 in step 811. In this case, in order to accurately receive the necessary contact by the RCS (CAB) server 72, steps 809 and 811 may be repeated. The RCS (CAB) server 72 converts the Non-RCS (CAB) contact to an RCS (CAB) format in step 813. The RCS (CAB) server 72 makes a request for the existing address book of the user stored in the network to the CAB AB application usage 73 in step 815. XCAP/HTTP GET may be used for the request. In responding to this, the CAB AB application usage 73 sends 200 OK including the requested address book of the user to the RCS (CAB) server 72 in step 817. Here, the RCS (CAB) server 72 performs the function of the application server 20 and the interworking server 30 of FIG. 2.

Accordingly, the RCS (CAB) server 72 filters the contacts by comparing the existing contacts of the user and new contact profiles received from the Non-RCS (CAB) address book systems 77 in step 819. The filtering of the contacts is performed in accordance with FIG. 4. The list of the filtered contacts is stored in the CAB AB application usage 73 in step 821. XCAP/HTTP PUT is used for the request for the storage of the list of the filtered contacts. The CAB AB application usage 73 stores the received contact profiles and sends the 200 OK as a confirmation response to the RCS (CAB) server 72 in step 823.

The RCS (CAB) server 72 notifies the RCS (CAB) client 71 of the change of the address book in step 825. OMA DS is used for the notification of the change of the address book. The RCS (CAB) client 71 performs a synchronization with the RCS (CAB) server 72 and receives new contact suggestions through the synchronization in step 827. Then, the RCS (CAB) client 71 notifies the user of the received contacts in accordance with the operation of FIG. 6 in step 829. As such, the RCS (CAB) client 71 may extend the subject seeking to grasp the success or failure of subscribing to the service through the interworking with the Non-RCS provider, i.e. the another service provider.

As described above, the first embodiment of the present invention has been described based on an example in which the RCS (CAB) server performs both the filtering function and the interworking function, the filtered contacts are managed in the CAB AB application usage 73, and the request of the user and the preference for the contact suggestions are stored in the document, CAB Feature Handler.

Prior to describing the second embodiment of the present invention, contents contained in the document, CAB Feature Handler are as follows.

In the present invention, a factor, <contact_suggestions>, is defined. The factor, <contact_suggestions>, is included in the document, CAB Feature Handler† when the RCS (CAB) client 71 desires to receive a list of new contact suggestions. A sub level of the factor, <contact_suggestions>, includes factors, <non-CAB source>, <credentials>, <preferences>, <scheduled-interval>, <max-suggestions>, <id>, <code>, and <response>.

First, <non-CAB source> is a factor for indicating an organization from which the RCS (CAB) client 71 desires to receive the new contact suggestions. For example, a domain name is indicated in <non-CAB source>. When there is no <non-CAB source>, the organization for reception of the new contact suggestions is determined in accordance with a policy of the service provider.

<credentials> refers to information necessary for an authentication when the RCS (CAB) client 71 accesses the organization. A sub level of <credentials> includes factors, <username> for indication of log-in information and <password> for indication of a password.

<preferences> may be replaced with <criteria> or <keywords>, and is used for setting a standard for a selection of a new contact suggestion. A sub level of <preferences> may include factors, <friend-of-friend>, <same-school>, <same-work>, <same-hobby>, <max-distance>, and <period>.

<friend-of-friend> may be also referred to as <mutual-friend>, and is set when the RCS (CAB) client 71 desires to receive contacts registered in a user's address book included in the organization, e.g. contacts of friends of the user (e.g. true or false).

<same-school> is used for direct entry of a corresponding school when the RCS (CAB) client 71 desires to receive a suggestion of contacts of people graduating from the corresponding same school. Otherwise, the RCS (CAB) server 72 accesses a user profile (the CAB PCC application usage 74) later and then utilizes a school name already indicated in <same-school>.

<same-work> is used for direct entry of a name of a corresponding company or a name of a type of job when the RCS (CAB) client 71 desires to receive a suggestion of contacts of people having the same job or contacts related to the same company. Otherwise, the RCS (CAB) server 72 accesses a user profile (the CAB PCC application usage 74) later and then utilizes a name of a company or a type of job already indicated in <same-work>.

<same-hobby> is used for direct entry of a corresponding hobby when the RCS (CAB) client 71 desires to receive a suggestion of contacts of people having the same hobby. Otherwise, the RCS (CAB) server 72 accesses a user profile (the CAB PCC application usage 74) later and then utilizes a hobby already indicated in <same-hobby>.

<max-distance> is used for entry of a maximally allowed distance between a present location of the user and a location according to the contact. For example, when 200 m is entered in <max-distance>, it means that the user desires to receive only contacts included within 200 m from the present location of the user. For example, <max-distance> is efficient when the user desires to receive contacts of businesses, such as restaurants, located in a neighboring area of the user.

<period> is used for setting a term of validity of a contact which the user desires to receive. For example, when a set term is from January 1 to January 10, the user receives contacts of which terms of validity overlap with the set term. <period> is efficient when the user desires to receive contacts valid only for a suggested term, such as a term of a concert or an exhibit in which the user is interested.

The aforementioned sub factors are merely examples, and keywords for a search may be directly inputted in <preferences> (or <criteria> and <keywords>). Further, even the factor, <preferences>, is not indicated, it may be determined in accordance with the user profile and the policy of the service provider by accessing the user profile (the CAB PCC application usage 74) by the RCS (CAB) server 72.

<scheduled-interval> is used for entry of a time interval suggestion when the RCS (CAB) client 71 desires to periodically, not once, receive a suggestion of contacts.

<max-suggestions> is used for setting the maximum number of contact suggestions which the RCS (CAB) client 71 desires to receive.

<id> is an IDentification (ID) for identifying respective requests.

Next, the RCS (CAB) server 72 organizes contents of the filtered contacts stored in the CAB AB application usage 73. For the organization, an address book format (structure) stipulated in the OMA CAB will be first described. The address book of the user includes the following factors.

<address-book> is a representative factor of the address book. A sub level of <address-book> may include one or more <contact> factors.

<contact> is a representative factor of one contact included in the address book. A sub level of <contact> may include one or more of <pcc> and <contact-status>.

<pcc (personal contact card)> contains detailed information on a contact, such as a name and an address of a contact. A sub level of <pcc> includes <person-details>, <org-details>, and <group-details>, and each element includes various sub-level elements. Factor, <location>, indicating location information on the contact is included in the sub-level element.

<contact-status> contains state information on the contact. A sub level of <contact-status> includes one or more of <contact-type>, <entry_status>, and <contact-source>.

<contact-type> indicates whether the contact is a CAB user, When the contact is not the CAB user, <contact-type> is omitted.

<entry_status> provides state information on the contact corresponding to the CAB user. A sub level of <entry_status> includes one factor of <updated> and <temporary>.

<updated> is information on a new contact which the user does not know yet or updated information on the existing contact, but <updated> is used when it is accepted to reflect the information on the new contact or the updated contact to the address book without a separate agreement (e.g. automatic agreement) of the user. Table 1 represents organized values available for <updated>.

TABLE 1

| Value | Definition |
|---|---|
| incoming subscription | value indicates that an incoming subscription |
| request | request is received from the associated contact |
| | (that is a CAB User) |
| contact subscription | value indicates that the contact was updated as |
| | a result of outgoing Contact Subscription updates |
| contact imported | value indicates that the contact was updated as a |
| | result of importing non-CAB data |
| contact-share | value indicates that accepted contact share data |
| | received has resulted in an updated Contact Entry |

The CAB client of the prior art removes a value of <updated> after the user reads a new contact.

<temporary> is information on a new contact which the user does not know yet or updated information on the existing contact, and is used when a prior agreement of the user is required before the reflection of the information on the new contact or the updated contact to the address book. Table 2 represents organized values available for <temporary>.

TABLE 2

| Value | Definition |
|---|---|
| contact subscription | value indicates that the contact was created as a |
| | result of outgoing Contact Subscription updates |
| contact imported | value indicates that the contact was created as a |
| | result of importing non-CAB data |
| incoming subscription | value indicates that the contact was created as |
| request | result of incoming subscription request from other |
| | CAB User |
| contact-share | value indicates that contact share data that was |
| | received needs to be confirmed and has resulted |
| | in a temporary Contact Entry |

The CAB client of the prior art removes a value of <updated> when the user agrees on the information on the new contact and removes the contact when the user does not agree on the information on the new contact.

<contact-source> indicates an organization providing the new contact or updated information on the existing contact.

According to the prior art, the storage of the contents in the CAB AB application usage 73 by the RCS (CAB) server 72 in step 821 of FIG. 8 means to provision of one or more of <contact> factors in the sub level of <address-book>. The following setting is applied according to a goal and an environment of the present invention, and information, which is not disclosed in the prior art, is added as follows.

<pcc> is information on a contact to provide. When there is the information (e.g. location information—<location>) necessary for the management of the temporary contact illustrated in FIG. 6, <pcc> also includes the information necessary for the management of the temporary contact.

<contact-type> is omitted because the contact is received from another service, i.e. the organization other than the CAB service.

<updated> or <temporary> under <entry-status> are used in accordance with the description of the prior art, but new values represented in Table 3 are applied to selected <updated> or <temporary>.

TABLE 3

| Value | Definition |
|---|---|
| contact_suggested | value indicates that the contact was created as a |
| | result of suggesting non-CAB contacts by the CAB |
| | service |

In order to continuously manage the temporary contacts illustrated in FIG. 6, a factor, <auto-remove>, in the same level as <updated> and <temporary> is defined. This is an example of the indication of being the temporary contact described in steps 415 and 607 of the present invention.

<auto-remove> is a factor indicating a type of standard for the automatic removal of the provided contact. A sub level of <auto-remove> includes one or more factors of <max_dist> and <validity_period>.

<max-distance> indicates a maximally allowed distance between a present location of the user and a location according to the contact. When the distance between the present position of the user and the location according to the contact exceeds the maximally allowed distance, the contact may be automatically removed.

<validity-period> is a term of validity of the contact. When the term of validity of the contact expires, the contact may be automatically removed according to the preference of the user.

For another example, <max-distance> and <validity-period> may be substituted for the existing sub level of <updated> and <temporary> for the application. However, according to the prior art, the CAB client is configured to remove <updated> or <temporary> after the user reads or agrees on the information on the new contact. When <max-distance> or <validity-period> exists in the sub level of <updated> or <temporary>, the CAB client 71 according to the embodiment of the present invention is required to continuously keep <updated> or <temporary> or separately keep information on <max-distance> and <validity-period>.

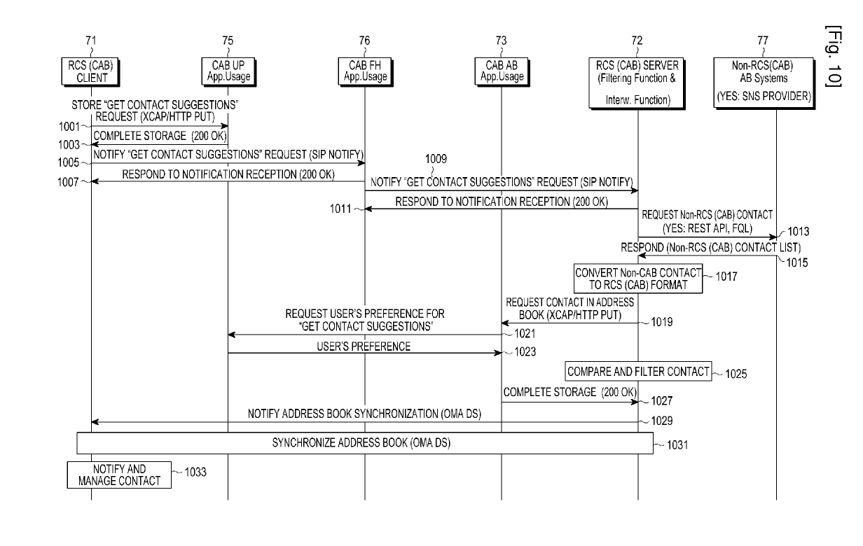

In the first embodiment of the present invention, when the user accesses the RCS services, in order for the RCS (CAB) client 71 to receive the list of the new contact suggestions, all detailed information containing the preference of the user is stored in the document, CAB Feature Handler† managed by the CAB FH application usage 76. In the meantime, according to a second embodiment of the present invention, in order for the RCS (CAB) client 71 to receive the list of the new contact suggestions, basic information necessary for receiving the list of the contact suggestions is continuously stored in the document, CAB Feature Handler† managed by the CAB FH application usage 76, and the user's preference for the list of the contact suggestions is separately stored in a document CAB User Preferences. This will be described with reference to FIG. 9.

FIG. 9 is a flowchart illustrating a process of providing contacts according to the second embodiment of the present invention.

When the user newly sets or updates the preference, the RCS (CAB) client 71 requests the CAB User Preferences (UP) application usage 75 to store the user's preference in the document CAB User Preferences managed by the CAB UP application usage 75 in step 901 of FIG. 9. The document CAB User Preferences will be described later in detail. The CAB UP application usage 75 stores the user's preference in the document CAB User Preferences and sends 200 OK as a storage completion response to the RCS (CAB client 71 in step 903.

Then, when the user accesses the RCS service, likewise to the aforementioned first embodiment of the present invention, the RCS (CAB) client 71 requests the CAB FH application usage 76 to store information on a request for a list of new contact suggestions in the document, CAB Feature Handler† managed by the CAB FH application usage 76 in order to receive the list of the new contact suggestions in step 905. Only the basic information necessary for the request itself is indicated in the document, CAB Feature Handler† and the user's preference for the list of the new contact suggestions is not included in the document, CAB Feature Handler. The CAB FH application usage 76 stores the information on the request for the list of the new contact suggestions in the document, CAB Feature Handler† managed by itself and sends 200 OK as a storage completion response to the RCS (CAB) client 71 in step 907.

Then, likewise to the aforementioned first embodiment of the present invention, the CAB FH application usage 76 notifies the RCS (CAB) server 72 of the information, which is requested by the RCS (CAB) client 71, stored in the document, CAB Feature Handler† in step 909. A SIP NOTIFY message is used for the notification. The RCS (CAB) server 72 receives the notification and sends 200 OK as a confirmation message to the CAB FH application usage 76 in step 911.

Next, the RCS (CAB) server 72 makes a request for user's preference for the list of the requested contact suggestions to the CAB UP application usage 75 through XCAP/HTTP GET in step 913. The CAB UP application usage 75 sends the user's preference stored in the document CAP User Preferences managed by itself to the RCS (CAB) server 72 through 200 OK in step 915.

Remaining steps 917 to 937 of FIG. 9 are the same as steps 809 to 829 of FIG. 8.

Contents included in the document CAB User Preferences according to the prior art will now be described.

<cab-upp> is a root factor in the highest level. A sub level of <cab-upp> includes a factor <cab-upp-set> related to the present invention among factors.

<cab-upp-set> is a factor indicating all user's preferences. A sub level of <cab-upp-set> includes one or more <profile> factors.

<profile> is a factor of a collection of user's preferences applied to a specific profile or environment (e.g. a house and an office) of the user. A sub level of <profile> includes factors, such as <update-ab>, indicating various preferences.

<update-ab> is a factor indicating the preference determining if the user's address book is directly and automatically updated or updated after receiving the agreement from the user when the user's address book is updated through a specific event. A sub level of <update-ab> includes a factor indicating corresponding preference for each event.

The aforementioned document CAB User Preferences additionally includes the following factors according to the second embodiment of the present invention.

A factor <auto-remove> is defined in the sub level of <profile>. When the contact is not satisfied with a specific standard (e.g. a location distance with the user and a term of validity) in the process of managing the contact added to the address book described with reference to FIG. 6, <auto-remove> processes the contact in accordance with the user's preference. That is, when the present location distance is beyond the standard as a result of the comparison with the standard stipulated in <max-distance> (defined in the sub level of <address-book>) or the present date is past the term of validity as a result of comparison with the standard stipulated in <validity-period>, a value of preference <auto-remove> is identified. When the value of <auto-remove> is true, the corresponding contact is automatically removed, and when the value of <auto-remove> is false, the user's agreement on the removal of the corresponding contact is first acquired. According to another implementation, When the value of <auto-remove> is true, the corresponding contact may not be permanently removed, but may be shifted to another storage, such as a removed contact box.

A factor, <contact-suggestions>, is defined in the sub level of <profile>. <contact-suggestions> corresponds to <contact-suggestions>, which is stored in the document, CAB Feature Handler† managed by the RCS (CAB) FH application usage 76 in the first embodiment of the present invention. That is, <contact-suggestions> is information transmitted by the RCS (CAB) client 10 in order to receive the list of the contact suggestions. However, contrary to the first embodiment of the present invention, only information related to the user's preferences is separately managed in the RCS (CAB) UP application usage 75 in the second embodiment of the present invention. Accordingly, the following preference factors, <friend-of-friend>, <same-school>, <same-work>, <same-hobby>, <max-distance>, <period>, and <max-suggestions>, are added to the sub level of <contact-suggestions>. The description and the usage method of each factor are the same as those in the first embodiment of the present invention.

A factor, <suggestions-update>, is defined in a sub level of <update-ab>. <suggestions-update> is a preference factor determining if the list of the new contacts is automatically added to the address book (<suggestions-update>=true) or is added after receiving the user's agreement (<suggestions-update>=false) when the list of the new contacts is to be suggested to the user. <suggestions-update> may be also applied to the first embodiment. When a value of <suggestions-update> is true, step 603 (waiting for the user's determination on the addition of the new contact to the address book) of FIG. 6 is omitted.

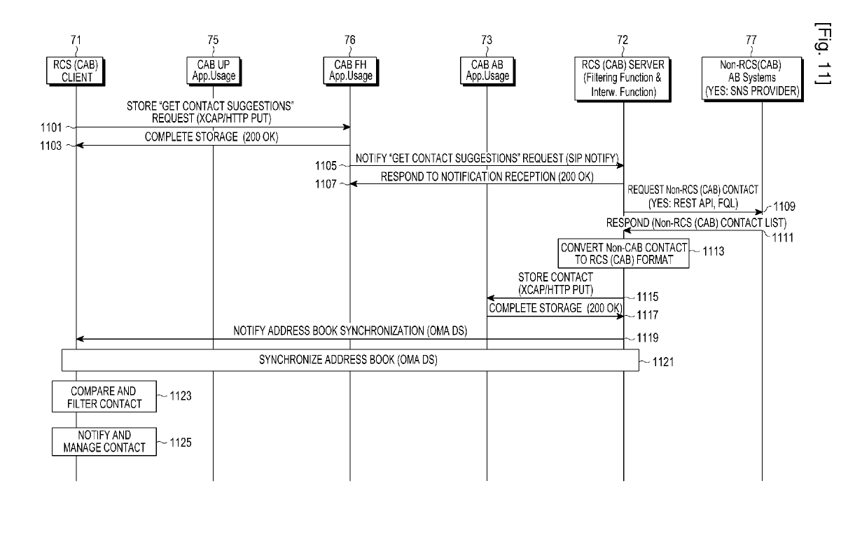

It is assumed in the first embodiment (step 819) and the second embodiment (step 927) that, as illustrated in FIG. 4, the RCS (CAB) server 72 performs the process of filtering the contact profiles by comparing the existing contact and preference of the user with the new contact profiles received from the Non-RCS (CAB) address book systems 77. However, the operations of the comparison and the filtering (i.e. the operation of FIG. 4) may be performed by another element. In a third embodiment of the present invention, it is assumed that the RCS (CAB) AB application usage 73 performs the filtering process. Accordingly, referring to FIG. 10, steps 1001 to 1011 are the same as steps 901 to 911 of FIG. 9. However, since the RCS (CAB) server 72 does not perform the filtering operation in the third embodiment of the present invention, it is not necessary to make a request for the user's preference for the filtering, contrary to the second embodiment of the present invention. Accordingly, the RCS (CAB) server 72 directly makes a request for new contacts to the Non-RCS (CAB) address book systems 77 in step 1013, receives a list of corresponding contacts in step 1015, converts the list of the contacts into an RCS (CAB) format in step 1017, and requests the CAB AB application usage 73 to directly store the converted list of the contacts without filtering the contacts in step 1019.

The CAB AB application usage 73 recognizes that the received request is a request for the storage of the list of the contacts for the purpose of suggesting the list of the new contacts to the user in step 1021. The CAB AB application usage 73 makes a request for user's preference related to a suggestion of the list of the contacts to the CAB UP application usage 75 in step 1021, receives the user's preference in step 1023, compares the new contacts with the user's preference and the contacts included in the user's address book and filters the new contacts in step 1025, and stores the contacts remaining after the filtering and sends a storage response message to the RCS (CAB) server 72 in step 1027. Steps 1029 to 1033 are the same as steps 933 to 937 of FIG. 9.

In a fourth embodiment of the present invention, the aforementioned comparison and filtering operations may be directly performed by the RCS (CAB) client 10. In this case, since the RCS (CAB) client 10 has already recognized the user's preferences through the user's input and separately keeps the address book in a device, the RCS (CAB) client 10 may perform the filtering and is not required to send the user's preference to the RCS (CAB) server 72 or the RCS (CAB) AB application usage 73.

FIG. 11 is a flowchart illustrating a process of providing contacts according to the fourth embodiment of the present invention. Referring to FIG. 11, steps 901 and 903 of FIG. 9, i.e. the processes of making the request for the storage of the user's preference to the CAB UP application usage 75 and sending the storage completion response, are omitted. Steps 1101 to 1107 are the same as steps 905 to 911 of FIG. 9. Steps 1109 to 1113 are the same as steps 917 to 921, except that the RCS (CAB) server 72 does not necessarily make a request for the user's preference. Steps 1115 to 1121 are the same as steps 929 to 935, except for that the RCS (CAB) server 72 does not necessarily make the request for the address book, compare the contacts, and filter the contacts. The RCS (CAB) client 10 performs the operation of FIG. 4 instead of the RCS (CAB) server 72 in step 1123, and notifies the user of the filtered contacts and manages the contacts according to the description of FIG. 6 in step 1125.

The present invention has an advantage of extending contact targets by receiving an extended address book from another service during the use of a messaging service. Accordingly, the user may automatically receive new contacts which are not included in the user's address book, and may easily and temporarily connect to another contact, such as a restaurant, which the user does not know but is related to the profile and the preference of the user, as well as existing friends and family members included in the address book. Further, when the user newly subscribes to a specific service, the present invention enables the user to conveniently and directly use the specific service.

Accordingly, the operation and the construction of the method and the apparatus of providing the contact without the interworking between the messaging service and another service may be implemented as described above. In the meantime, the exemplary embodiments of the present invention have been provided in the description of the present invention, but various modifications may be implemented within the scope of the present invention.

### SEQUENCE LISTING FREE TEXT

[1] SyncML Representation Protocol, Data Synchronization Usage, Version 1.2,

Open Mobile Alliance, OMA-TS-DS_DataSyncRep-V1_{—}2, URL: http://www.openmobilealliance.org/
[2] Session Initiation Protocol (SIP)-Specific Event Notification, RFC 3265, URL: http://www.ietf.org/rfc/rfc3265.txt
[3] XML Configuration Access Protocol, RFC 4825, RFC 4826, RFC 4827

1. A method of providing contact information through an interworking between a messaging service and another service, the method comprising:
receiving a preference of a user from an application client by an application server;
receiving a request for a list of new contacts from the application client;
transferring the request for the list of the new contacts to an interworking server;
receiving a profile of the contact from a service provider through the interworking server;
filtering the received profile of the contact; and
transferring a list of filtered contacts to the application client.

2. The method as claimed in claim 1, wherein filtering of the received profile of the contact comprises:
extracting data, from which the contact can be identified, from the received profile of the contact;
comparing the extracted data, from which the contact can be identified, with data of an address book stored in an address book management unit of the application server, and determining if the received profile of the contact corresponds to the data stored in the address book;
when the received profile of the contact does not correspond to the data stored in the address book, extracting data corresponding to the preference of the user from the received profile of the contact;
determining if the extracted data corresponding to the preference of the user corresponds to a preference of the user stored in a preference management unit of the application server; and
when the extracted data corresponding to the preference of the user corresponds to the preference of the user stored in the preference management unit of the application server, adding an indication of being a temporary contact to the received profile of the contact.

3. The method as claimed in claim 2, further comprising, when the received profile of the contact corresponds to the data stored in the address book as a result of determining if the received profile of the contact corresponds to the data stored in the address book, removing the received profile of the contact.

4. The method as claimed in claim 2, further comprising, when the extracted data corresponding to the preference of the user does not correspond to the preference of the user stored in the preference management unit of the application server, removing the received profile of the contact.

5. The method as claimed in claim 2, wherein the data from which the contact can be identified includes at least one of a name, an email address, a telephone number, and a received service.

6. An application server for providing contact information through an interworking between a messaging service and another service, the application server comprising:
a memory for storing data necessary for operating the application server and storing a list of contact profiles received from a service provider;
an I/O interface for transceiving information with other system elements;
an address book management unit for storing information on an address book synchronized with an address book of an application client; and
a controller for receiving a preference of a user from the application client, receiving a request for a list of new contacts from the application client, transferring the request for the list of the new contacts to an interworking server, receiving a profile of the contact from a service provider through the interworking server, filtering the received profile of the contact, and transferring a list of filtered contacts to the application client.

7. The application server as claimed in claim 6, further comprising a preference management unit for storing the preference of the user received from the user.

8. The application server as claimed in claim 6, wherein the controller extracts data, from which the contact can be identified, from the received profile of the contact through filtering the received profile of the contact, compares the extracted data from which the contact can be identified with data of an address book stored in the address book management unit of the application server and determines if the received profile of the contact corresponds to the data stored in the address book, extracts data corresponding to the preference of the user from the received profile of the contact when the received profile of the contact does not correspond to the data stored in the address book, determines if the extracted data corresponding to the preference of the user corresponds to a preference of the user stored in a preference management unit of the application server, adds an indication of being a temporary contact to the received profile of the contact when the extracted data corresponding to the preference of the user corresponds to the preference of the user stored in the preference management unit of the application server.

9. The application server as claimed in claim 8, wherein, when the received profile of the contact corresponds to the data stored in the address book as a result of the determination on if the received profile of the contact corresponds to the data stored in the address book, the controller removes the received profile of the contact.

10. The application server as claimed in claim 8, wherein, when the extracted data corresponding to the preference of the user does not correspond to the preference of the user stored in the preference management unit of the application server, the controller removes the received profile of the contact.

11. The application server as claimed in claim 8, wherein the data from which the contact can be identified includes at least one of a name, an email address, a telephone number, and a received service.

12. A method of receiving contact information through an interworking between a messaging service and another service, the method comprising:
transmitting a request for a list of new contacts to an application server by an application client;
receiving a list of filtered contacts from the application server by the application client;
displaying the received list of the filtered contacts;
adding the received list of the filtered contacts to an address book; and
removing the added list of the filtered contacts according to a preset standard.

13. The method as claimed in claim 12, wherein removing of the added list of the filtered contacts according to the preset standard comprises:
identifying if a profile of the added contact includes an indication of being a temporary contact;
when the profile of the added contact includes the indication of being the temporary contact, identifying a storage standard of the profile of the contact including the indication of being the temporary contact;
when the profile of the contact including the indication of being the temporary contact satisfies the storage standard, periodically checking the storage standard; and
when the profile of the contact including the indication of being the temporary contact does not satisfy the storage standard, removing the profile of the contact including the indication of being the temporary contact.

14. The method as claimed in claim 13, wherein the storage standard includes at least one of a location of the application client and a preset term.

15. An application client for receiving contact information through an interworking between a messaging service and another service, the application client comprising:
a memory for storing data necessary for operating the application client;
an I/O interface for transceiving information with other system elements;
an address book management unit for storing information on an address book;
a user interface for inputting/outputting data; and
a controller for transmitting a request for a list of new contacts to an application server, receiving a list of filtered contacts from the application server, displaying the received list of the filtered contacts, adding the received list of the filtered contacts to the address book, and removing the added list of the filtered contacts according to a preset standard.

16. The application client as claimed in claim 15, wherein, when the controller removes the added list of the filtered contacts according to the preset standard, the controller identifies if a profile of the added contact includes an indication of being a temporary contact, identifies a storage standard of the profile of the contact including the indication of being the temporary contact when the profile of the added contact includes the indication of being the temporary contact, periodically identifies the storage standard when the profile of the contact including the indication of being the temporary contact satisfies the storage standard, and removes the profile of the contact including the indication of being the temporary contact when the profile of the contact including the indication of being the temporary contact does not satisfy the storage standard.

17. The application client as claimed in claim 16, wherein the storage standard includes at least one of a location of the application client and a preset term.
